(19) United States
(12) Patent Application Publication
(10) Pub. No.: US 2001/0020253 A1
(43) Pub. Date: Sep. 6, 2001

(54) Brokerage system and method for joint learning of different languages

(75) Inventor: Shinya Arao, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/795,618

(22) Filed: Feb. 28, 2001

(30) Foreign Application Priority Data
Mar. 1, 2000 (JP) 055640/2000

(51) Int. Cl. G06F 15/173; G06F 15/16

(52) U.S. Cl. 709/228; 709/204; 709/226; 709/203

(57) ABSTRACT

An environment enabling members to easily teach each other in order to learn a foreign-language conversation by utilizing the Internet chat service. A member profile server retrievably stores a plurality of member profiles for respective ones of registered members. Each of the member profiles includes at least native language information and interest language information of a corresponding registered member. When a registered member has been logged in, a broker allocates the registered member to a chat corner permitting a predetermined pair of languages that matches a combination of native language information and interest language information of the logged-in registered member.

### BACKGROUND OF THE INVENTION

1. Field of the Invention

The present invention relates to brokerage system and method for joint language learning utilizing the Internet, and learning of different languages.

2. Description of the Related Art

A group lesson at a language school or in a language laboratory is effective means for learning a conversation in a foreign language. For example, a group lesson has been provided for a few persons in a class of English conversation. For taking such a lesson, the learners must attend the school or the class, and must pay usually expensive school fee.

In the mean time, an Internet chat service has already come to be widely spread. A plurality of learners can practice a conversation by directly writing on the Internet. In this case, various kinds of chat corners classified under various themes are provided. A user can freely participate in a theme in which the user is interested from the terminal of the user's personal computer or the like.

### SUMMARY OF THE INVENTION

It is an object of the present invention to provide an environment enabling members to easily teach each other in order to learn a conversation in a foreign language by utilizing the Internet chat service.

It is another object of the present invention to provide an environment enabling members to carry out a conversation in a foreign language for each other with a native-speaker member in a foreign country while the members are at home.

According to an aspect of the present invention, a system includes: a chat server providing chat services; a member profile server retrievably storing a plurality of member profiles for respective ones of registered members, each of the member profiles including at least native language information and interest language information of a corresponding registered member; and a broker for allocating a registered member who has logged in to a chat corner permitting a predetermined pair of languages that matches a combination of native language information and interest language information of the logged-in registered member.

The broker preferably puts an upper limit to participants in the chat corner, wherein when the number of participants exceeds the upper limit, the broker divides the participants into a plurality of chat groups of the chat corner so as to set the number of participants in each of the chat groups to the upper limit or less.

The broker may distribute the logged-in registered member to one of the chat groups so as to make the number of participants uniform in each of the chat groups.

The broker may cause a browser of the logged-in registered member to display a chat web page after the logged-in registered member has been allocated to the chat corner or the chat group. The broker may allow each of participants in the chat corner to access a member profile of another participant in the member profile server. When a participant requests a member profile of another participant, the broker accesses the member profile server to generate a web page of the requested member profile so that the web page is displayed on a browser of the participant. The web page of the requested member profile may include a hyperlink having an Internet telephony terminal address of the other participant.

According to another aspect of the present invention, a brokerage method in a system having a chat server providing chat services, includes the steps of: a) retrievably storing a plurality of member profiles for respective ones of registered members in a member profile server, each of the member profiles including at least native language information and interest language information of a corresponding registered member; b) when a login request of a registered member occurs, receiving a combination to native language information and interest language information of the logged-in registered member from the member profile server; and c) allocating the logged-in registered member to a chat corner permitting a predetermined pair of languages that matches the combination of native language information and interest language information of the logged-in registered member.

According to the present invention, there is provided a service system for the intermediary and a chat for joint learners of a foreign language between persons in foreign countries by utilizing the Internet. Based on this system, Internet users can become members of this service by paying a member fee to a service company, and then can receive the service. The service company registers a member profile including parameters of “native language” and “interested language (a foreign language for learning)” into a member profile server via the ISP (Internet Service Provider) which Internet users as members have joined. The member profile server keeps the data of the member profiles of individual registered members. When a member have logged in this service to make a request for participating in the chat, a language learning community broker operated by the service company refers to the native language and the “interested language”, and allocates the logged-in member to a chat corner that permits only these two languages.

A member participating in a chat corner can observe the profile of another member who participate in the same chat corner. The member can establish communication through Internet telephony by referring to Internet telephony terminal address registered in the profile of the other member. In other words, the present invention provides a chat service for language learners and an intermediary service for introducing language learners who can teach languages to each other. An Internet user can register the user's member profile in the member profile server by paying the member fee to the service company regardless of which ISP the user belongs to.

Each of the member profiles is composed of parameters or personal information, and is inputted by a corresponding member. The contents of the member profile are examined by the service company to confirm the correctness of the contents. For example, a name, a photograph of the face, age, gender and residence in the member profile can be confirmed based on a driver's license or the like. After the service company has examined the contents of the input member profile, the service company gives a log-in name and a password to this Internet user. The member profile has an object that is used to introduce a member living in the own country or in a foreign country to another member. In other words, the member profile is used for introducing the information including a photograph of the face, an academic background, an interested language, hobbies, etc. and the address information for calling the Internet telephony terminal of the other member. Further, the member profile is also used for authenticating the log-in of the member to the service. However, this in not made open except to the service provider and the member himself/herself.

In the present invention, the intermediary service for introducing persons who can teach foreign languages to each other between persons of different countries is provided at two steps. First, when a member has logged in the present service, the member can utilize a special chat service for teaching languages to each other between persons in different countries. This chat service has a rule that only the two languages of the “native language” and the “interested language” can be used. Members may be allocated to a plurality of chat groups in the same chat corner, each group having an upper limit in the number of participants. These groups are operated in parallel.

For example, for persons who are Japanese member and who want to learn German and for persons who are German members and who want to learn Japanese, a chat corner in which only Japanese and German can be used is provided. Then, the language learning community broker allocates the members among the plurality of groups.

Further, a member participating in a chat corner can look at the profile of another member who participate in the same chat corner. With this arrangement, a member can communicate with another member using the Internet telephony function. The Internet chat service can be utilized psychologically comfortably, but also has a difficulty in mastering a language as only characters can be used. In order to obtain practical learning effect, both “listening” and “speaking” are necessary. When a member refers the Internet telephony terminal address included in the member profile, it is possible to establish Internet telephony communication with the other member. The Internet telephony is a service area of the Internet telephony service provider, and is not included in the service area of the present invention.

### BRIEF DESCRIPTION OF THE DRAWINGS

FIG. 1 is a schematic diagram showing an embodiment of the present invention;

FIG. 2 is a diagram showing parameters of a member-profile used in the present invention;

FIG. 3 is a flowchart for explaining the operation of the present invention;

FIG. 4 is a log in screen displayed when an access has been made to the service of the present invention;

FIG. 5 is a diagram for explaining a grouping of a chat in the present invention;

FIG. 6 is a diagram showing a client side screen when a chat is being carried out; and

FIG. 7 is a diagram showing a chat client side screen when a member profile reference link has been clicked.

### DESCRIPTION OF THE PREFERRED EMBODIMENTS

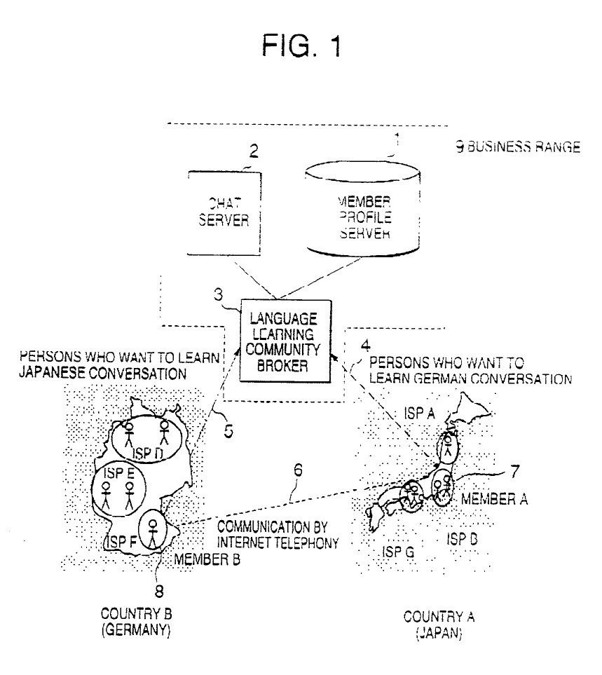

As shown in FIG. 1, a service provider (9) of the present service operates a member profile server (1), a chat server (2), and a language learning community broker (3). Therefore, the present service provider has a business range encircled by a broken line.

Here, as an example, there are shown Internet users who live in Japan and want to learn German. Internet users who live in Germany and want to learn Japanese, and ISPS (Internet Service Providers) A to F that are used by them. It is assumed that there are the ISPS A to C in Japan and the ISPS D to F in Germany, and that the present service provider (9) is located at a geographically neutral position. It is also assumed that web browsers of members in both countries communicate with the language learning community broker (3) as indicated by reference numeral 4 and 5.

The language learning community broker (3) is a web server for realizing the present service. The language learning community broker (3) can provide the services the present embodiment while referring to the member profile server (1) and the chat server (2). In FIG. 1, a Japanese member A (7) and a German member B (8) have currently logged in this service. The member A and the member B carry out the Internet telephony communication (6) when necessary.

The member profile server (1) registers a plurality of member profiles of registered members, which can be retrieved in response to a search request from the language learning community broker (3), as will be described later.

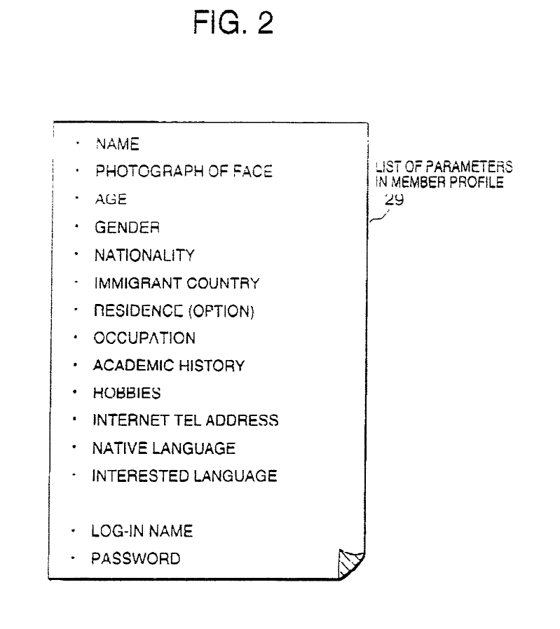

As shown in FIG. 2, each of the member profiles registered in the member profile server (1) includes predetermined parameters that are used in the present system. At least parameters of “native language” and “interested language” are needed to determine the kind of a chat corner in which the member is to participate. Preferably the parameter of “Internet telephony terminal address” is included to intermediate the learning of a language in voice.

OPERATION

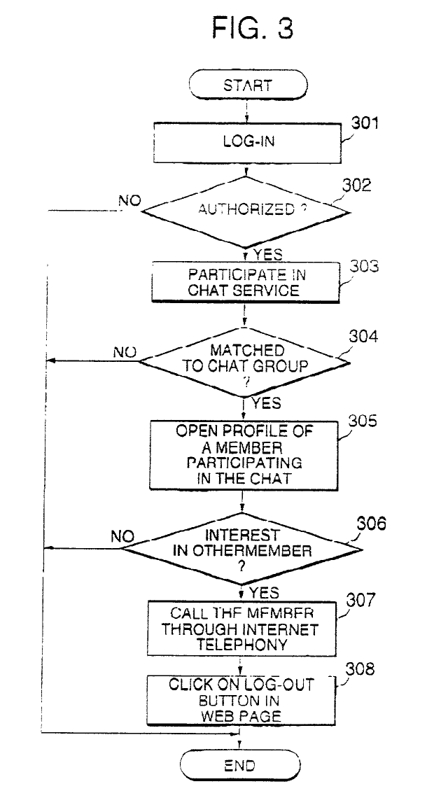

Hereafter, an operation of the present embodiment will be described in detail by referring to FIGS. 3-7.

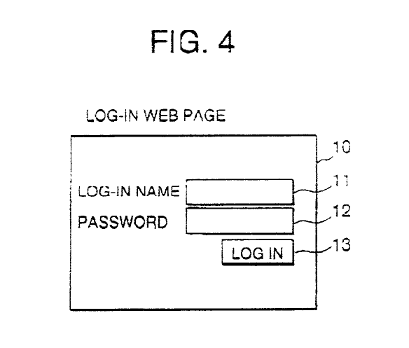

Referring to FIG. 3, when the member A has accessed the language learning community broker (3) using the web browser, a log-in web page (10) as shown in FIG. 4 is displayed first on the member's browser. The member A inputs a log-in name (11) and a password (12), and then clicks on a log-in button (13) (step 301).

When the log-in name (11) and the password (12) that have been input are authorized (YES at step 302), the language learning community broker (3) reads the “native language” and the “interested language” in the parameters (29) of the member profile from the member profile server (1). Then, the language learning community broker (3) allocates the member A (7) to a chat corner in which the member A wants to participate. When the member A living in Japan wants to learn German, the member A is allocated to a chat corner permitting both Japanese and German to be used. Japanese and German members are mainly allocated to this chat corner. When the log-in name and the password that have been input are not authorized, the member A cannot attend the chat service (NO at step 302).

In this case, a limit is preferably set to the number of persons who can join one chat group. When the number of persons joining this group exceeds a predetermined limit, a member who has logged in later is allocated to another group of the same chat corner.

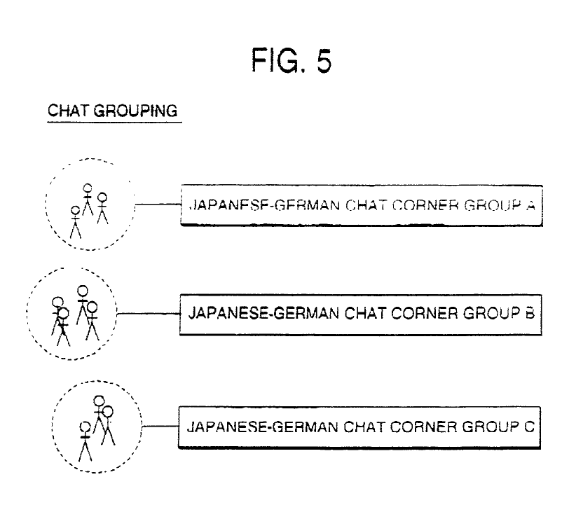

FIG. 5 shows a state that three chat groups in the chat corner permitting both Japanese and German, A, B and C, are created by the language learning community broker (3). The upper limit of the number of log-in members per one chat group is set to an optimum number in order to disperse the load of the network and to increase the efficiency of the chat. When the number of log-in persons exceeds the limit number, a new chat group is created. Persons using Japanese as native language and persons using German as native language are uniformly allocated among the chat groups.

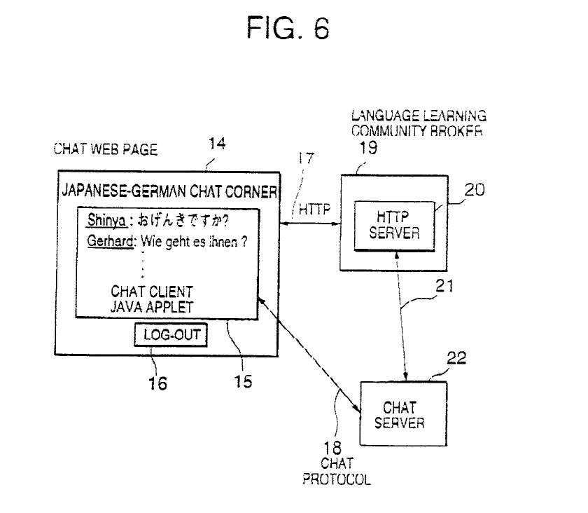

When a group in which the logged-in member A participate has been determined, the language learning community broker (3) generates a web page (14) embedded with a Java Applet chat client (15) of shown in FIG. 6, and displays this web page on the browser of the member A (7). Starting from this point of time the member A can enjoy a chat with other members who are on service (step 303 in FIG. 3).

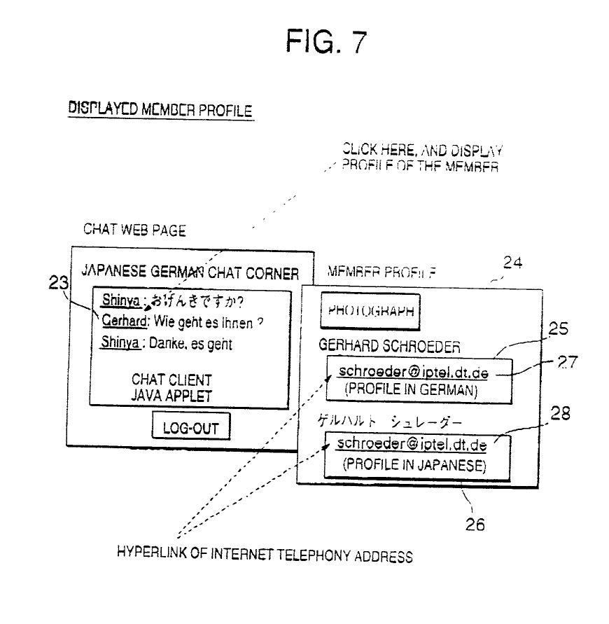

The member A (7) enjoys a conversation with other members for some time through the chat service. In this case, when the member A has decided that the chat with member B (8) living in Germany has become livelier, or when the interesting areas of both members have overlapped with each other, for example, (YES at step 304), the member A clicks a member profile reference link (23) of the member B within the Java Applet, as shown in FIG. 7.

When this link as been clicked, the language learning community broker (3) communicated with the member profile server (1) to generate a web pate (24) that shows the profile of the member B, so that a new window is created in the browsers of the member A, and the web page (24) is displayed in this window. Therefore, the member A can look at the profile of the member B shown in the new opened window of the browser of the member A, and confirms the personal information (step 305). For example, the personal information such as gender, age a photograph of his/her face, the academic background, and the residence is displayed in the window. The correctness of the contents of the member profile has been guaranteed by the service company. When the chat group does not match, (NO at step 304), the member A can log out.

If the member A has an interest in the member B (8) by looking at the profile of this member (YES at step 306), the member A can establish communication with the member B by clicking an Internet telephony terminal address (27, 28) of the member B displayed in the profile as shown in FIG. 7 (step 307). With this arrangement, the member A can learn the language through actual conversation not only by reading and writing. Further, the member A can enjoy the conversation with the member B. When the member A has no interest in the member B (NO at step 306), the member A can log out.

The Internet telephony terminal address (27, 28) is a Hyperlink having the address information of the member B for starting the Internet telephony terminal software. How to process this Hyperlink, or which software and protocol of the Internet telephony are to be started, or whether it is possible to communicate with two or more persons at the same time by using the multicast, depends on the software of the respective Internet telephony terminals and Internet telephony service providers. As described, the communications based on the Internet telephony are not within the scope of the present invention.

As shown in FIG. 6, a logged-in member can log out at any moment by clicking on a log-out button (16) on the web page (step 308). This log-out button is always displayed on any web pate generated by the language learning community broker (3). Further, it is also possible to design the service such that when a logged-in member has forgotten to log out, the chat server (2) detects such a member who has taken no action for a predetermined time period or more to automatically log out the member and delete from the server.

The language learning community broker (19) had an HTTP (Hyper Text Transfer Protocol) server (20) therein, and the HTTP server (20) communicates with the web browser of a member through the Internet. This language learning community broker (19) notifies the chat server (22) of distribution of the logged-in members to appropriate groups of the chat corner. The Java Applet (15) of the chat client (member) communicates with the chat server (22) according to the chat protocol (18).

FIG. 7 shows a state that a member has clicked the member profile Hyperlink (23) in the web page of the chat to display the profile (24) of the member of interest. As this is the Japanese and German chat corner, a profile (25) described in German and a profile (26) described in Japanese are both displayed. Each profile includes the Internet telephony terminal address (27, 28) of the member of interest. This Internet telephony terminal address is a Hyperlink. When this address is clicked, the software of the Internet telephony starts, and it becomes possible to start communication with the member of interest by the Internet telephone.

As described above, according to the present invention, persons in the different countries, for example, can easily teach their own languages to each other through the Internet chat. Therefore, it is possible to learn a foreign language without the need for paying expensive lecture fees like that required at a language school. Further, based on the utilization of the Internet, it is possible to learn a language at home.

Furthermore, it is possible to communicate with another member of interest through the Internet telephony by clicking on the Internet telephony address that is displayed in the member profile of the member. Therefore, it is possible to further develop the learning of the foreign language. In addition, it is possible to make a strong appeal to Internet users who want to make friends in foreign countries.

In the above embodiment, a description has been made of the service between different countries (e.g. Germany and Japan). However, the above embodiment shown only one example. As another embodiment of the present invention, it is preferable that the service is designed to be utilized between members located in the same country. For example, in the case where there are a German person who wants to learn Japanese and a Japanese person who wants to learn German, both living in Japan, the present invention can be also applied. In this case, the service is utilized within the same country.

What is claimed is:

1. A system comprising:
a chat server providing chat services;
a member profile server retrievably storing a plurality of member profiles for respective ones of registered members, each of the member profiles including at least native language information and interest language information of a corresponding registered member; and
a broker for allocation a registered member who has logged in to a chat corner permitting a predetermined pair of languages that matches a combination of native language information and interest language information of the logged-in registered member.

2. The system according to claim 1, wherein the broker puts an upper limit to participants in the chat corner, wherein when the number of participants exceeds the upper limit, the broker divides the participants into a plurality of chat groups of the chat corner so as to set the number of participants in each of the chat groups to the upper limit or less.

3. The system according to claim 2, wherein the broker distributes the logged-in registered member to one of the chat groups so as to make the number of participants uniform in each of the chat groups.

4. The system according to claim 1, wherein the broker causes a browser of the logged-in registered member to display a chat web page after the logged-in registered member has been allocated to the chat corner.

5. The system according to claim 4, wherein the broker allows each of participants in the chat corner to access a member profile of another participant in the member profile server

6. The system according to claim 5, wherein, when a participant requests a member profile of another participant, the broker accesses the member profile server to generate a web page of the requested member profile so that the web page is displayed on a browser of the participant.

7. The system according to claim 6, wherein the web page of the requested member profile includes a hyperlink having an Internet telephony terminal address of the other participant.

8. The system according to claim 2, wherein the broker causes a browser of the logged-in registered member to display a chat web page after the logged in registered member has been allocated to a chat group.

9. The system according to claim 8, wherein the broker allows each of participants in the chat group to access a member profile of another participant in the member profile server.

10. The system according to claim 9, wherein, when a participant requests a member profile of another participant, the broker accesses the member profile server to generate a web page of the requested member profile so that the web page is displayed on a browser of the participant.

11. The system according to claim 10, wherein the web page of the requested member profile includes a hyperlink having an Internet telephony terminal address of the other participant.

12. The system according to claim 4, wherein the chat web page is embedded with a chat client of Java applet.

13. The system according to claim 8, wherein the chat web page is embedded with a chat client of Java applet.

14. The system according to claim 1, wherein the registered members are allowed to access the broker through the Internet.

15. A brokerage method in a system having a chat server providing chat services, comprising the steps of:
a) retrievably storing a plurality of member profiles for respective one of registered members in a member profile server, each of the member profiles including at least native language information and interest language information of a corresponding registered member;
b) when a login request of a registered member occurs, receiving a combination of native language information and interest language information of the logged-in registered member from the member profile server; and
c) allocating the logged-in registered member to a chat corner permitting a predetermined pair of languages that matches the combination of native language information and interest language information of the logged-in registered member.

16. The method according to claim 15, wherein an upper limit to participants is set in the chat corner, further comprising the step of:
when the number of participants exceeds the upper limit, dividing the participants into a plurality of chat groups of the chat corner so as to set the number of participants in each of the chat groups to the upper limit or less

17. The method according to claim 16, wherein the logged-in registered member is allocated to one of the chat groups so as to make the number of participants uniform in each of the chat groups.

18. The method according to claim 15, further comprising the step of:
d) causing a browser of the logged-in registered member to display a chat web page.

19. The method according to claim 18, wherein the chat web page is embedded with a chat client of Java applet.

20. The method according to claim 19, wherein each of participants in the cat corner is allowed to access a member profile of another participant in the member profile server by clicking on a participant name on the chat client.

21. The method according to claim 20, further comprising the steps of:
when a participant requests a member profile of another participant, accessing the member profile server to generate a web page of the requested member profile; and
causing a browser of the participant to display the web page thereon.

22. The method according to claim 21, wherein the web page of the requested member profile includes a hyperlink having an Internet telephony terminal address of the other participant.
